(19) United States
(12) Patent Application Publication
(10) Pub. No.: US 2020/0323049 A1
(43) Pub. Date: Oct. 8, 2020

(54) METHOD FOR A HEATING OF A TOOL HOLDER BY MEANS OF AN INDUCTION HEATING DEVICE, AND SHRINK-CLAMPING AND/OR UNSHRINK-UNCLAMPING STATION FOR TOOLS

(71) Applicant: E. Zoller GmbH & Co. KG Einstell- und Messgeraete, Pleidelsheim (DE)

(72) Inventors: Alexander ZOLLER, Pleidelsheim (DE); Christian PFAU, Ingersheim (DE)

(21) Appl. No.: 16/838,770

(22) Filed: Apr. 2, 2020

(30) Foreign Application Priority Data
Apr. 4, 2019 (DE) 10 2019 108 906.9

(51) Int. Cl. H05B 6/14; B23P 11/02; H05B 6/36; H05B 6/06

(52) U.S. Cl. CPC H05B 6/14; H05B 6/06; H05B 6/36; B23P 11/027

(57) ABSTRACT

A method for a heating of a tool holder by means of an induction heating device for the purpose of a shrink-clamping and/or unshrink-unclamping of tools into and/or from tool holders includes an induction heating unit having at least one, preferably exclusively one, induction coil and is configured to expand by heating at least a portion of the tool holder, in particular at least a clamping region of the tool holder, in a shrink-clamping process or in an unshrink-unclamping process, and the induction coil is moved during an induction heating process.

### CROSS REFERENCE TO RELATED APPLICATION

This application is based on German Patent Application No. 10 2019 108 906.9 filed on Apr. 4, 2019, the contents of which are incorporated herein by reference.

### STATE OF THE ART

The invention relates to a method for a heating of a tool holder by means of an induction heating device, and to a shrink-clamping and/or unshrink-unclamping station for tools.

A method for a heating of a tool holder by means of an induction heating device for the purpose of a shrink-clamping and/or unshrink-unclamping of tools into and/or from tool holders has already been proposed, with an induction heating unit which comprises at least one induction coil and which is configured to expand at least a portion of the tool holder by heating in a shrink-clamping process or in an unshrink-unclamping process.

The objective of the invention is in particular to provide a method with advantageous properties regarding a heating of tool holders for a shrink-clamping process or an unshrink-unclamping process of tools.

### ADVANTAGES OF THE INVENTION

The invention is based on a method for a heating of a tool holder by means of an induction heating device for the purpose of a shrink-clamping and/or unshrink-unclamping of tools into and/or from tool holders, in particular by means of an induction heating unit of a shrink-clamping and/or unshrink-unclamping station for tools, wherein an induction heating unit comprises at least one, preferably exclusively one, induction coil and is configured to expand by heating at least a portion of the tool holder, in particular at least a clamping region of the tool holder, in a shrink-clamping process or in an unshrink-unclamping process.

It is proposed that at least the induction coil is moved, in particular actively moved, during an induction heating process. In this way advantageous heating characteristics are achievable. In particular it is advantageously possible to achieve an even heating of a clamping region of a tool holder. In particular a heating region, within which a tool holder is heated in the shrink-clamping process or in the unshrink-unclamping process by an induction-magnetic field of the induction coil, is accurately adaptable to a length of an intended clamping region of the tool holder. Moreover, it is in this way advantageously possible for the induction heating device to be realized in a particularly simple fashion, for example comprising only one single coil winding, which preferably has an axial extension which is smaller than a smallest clamping-in height that is to be expected or which corresponds to the smallest clamping-in height that is to be expected. This advantageously allows achieving an induction heating device that is especially cost-efficient and/or has a particularly low tendency to faulty behavior. In particular it is advantageously possible to keep a height of the induction coil, in particular of the windings of the induction coil, comparably small.

By a “tool holder” is in particular a structural component to be understood which is configured for an accommodation of a tool and for a connection of the tool to a machine. In particular the tool holder is implemented as a tool-machine interface. The tool holder is preferentially embodied as a tool chuck, in particular a shrink-chuck. In particular the tool holder comprises a tool receiving opening, which is configured for receiving a tool and to hold it at least in a force-fit manner. The tool may in particular be embodied as a shaft tool, preferably as a rotary shaft tool, e.g. as a drill, as a milling device, as a profiling tool and/or as a reamer. By a “shrink-clamping of tools into and/or from tool holders” is in particular a clamping-in of tools in tool holders to be understood, in which a tool receiving opening of the tool holder is first of all expanded thermally, then a tool is inserted in the tool receiving opening and wherein eventually, following a cooling down of the tool holder, the tool is fixated in the tool holder by way of a force fit, in particular friction-fit. By an “unshrink-unclamping of tools in and/or from tool holders” is in particular a releasing of tools which are fixated in tool holders by means of a force fit, in particular a friction-fit, in which the tool receiving opening of the tool holder is expanded thermally, in particular while avoiding a simultaneous heating of the tool by means of a screening unit, until the tool fixated in the tool holder is removable from the tool holder.

By a “shrink-clamping and/or unshrink-unclamping station for tools” is in particular a device to be understood that is configured to carry out a shrink-clamping process and/or an unshrink-unclamping process of tools in tool holders, preferentially in an at least largely automated manner, preferably in a fully automated manner. By “at least a portion of the tool holder” or by a “clamping region of the tool holder” is in particular at least one region of the tool holder to be understood which encompasses the tool receiving opening of the tool holder, in particular in a radial direction of the tool receiving opening. In the “shrink-clamping process” a tool is fixated in the tool holder at least by force-fit while making use of heat expansion characteristics of a material of the tool holder. In the “unshrink-unclamping process” a too that is fixated in the tool holder at least by force-fit is removed from the tool holder while making use of the heat expansion characteristics of the material of the tool holder. By an “induction heating process” is in particular at least a part of the shrink-clamping process or of the unshrink-unclamping process to be understood during which the tool holder is heated by a magnetic field generated by the induction coil. An “active movement” is in particular to mean a movement that is induced at least by a drive unit, for example a drive unit of the induction heating device and/or of the shrink-clamping and/or unshrink-unclamping station, and/or which is controlled and/or regulated at least via a control and/or regulation unit, for example a control and/or regulation unit of the induction heating device and/or of the shrink-clamping and/or unshrink-unclamping station. By a “control and/or regulation unit” is in particular a unit to be understood which has at least one control electronics component. By a “control electronics component” is in particular a unit, with a processor unit and with a memory unit as well as with an operation program stored in the memory unit, to be understood. “Configured” is in particular to mean specifically programmed, designed and/or equipped. By an object being configured for a certain function is in particular to be understood that the object fulfills and/or carries out said certain function in at least one application state and/or operation state. In particular the induction heating unit comprises precisely one induction coil, the coil windings of which extend in an axial direction of the induction coil over a length corresponding to a clamping region of a smallest tool holder that can be clamped by the induction heating device.

If the induction coil is moved oscillatingly during the induction heating process, advantageous heating characteristics are achievable. An especially even heating of a clamping region of a tool holder is in particular advantageously achievable. By an “oscillating movement” is in particular a swinging, in particular rhythmically swinging, spatial movement to be understood, preferably an up-and-down movement, which preferentially swings along a vertical axis, about a fix point. In particular, the oscillating movement is to be understood as a pulsed movement. In particular, the induction coil is translationally oscillated during the induction heating process.

Furthermore it is proposed that during the induction heating process, the induction coil is moved along an axial direction of the tool holder that is to be heated and/or along an axial direction of the induction coil. This allows achieving advantageous heating characteristics. In particular, an even heating of a clamping region of a tool holder is advantageously achievable. The axial direction of the tool holder in particular extends along a designated rotation axis of the tool holder and/or of a tool that is fixated in the tool holder. The axial direction of the induction coil in particular extends centrally through an interior of the coil winding of the induction coil. The axial direction of the induction coil and the axial direction of the tool holder are usually at least substantially identical to one another during the shrink-clamping process or during the unshrink-unclamping process.

It is moreover proposed that during the induction heating process, the induction coil and/or the tool holder are/is rotationally moved at least partially around a rotation axis extending in parallel to an axial direction of the tool holder, which is in particular a rotation axis of the induction coil or of the tool holder. This advantageously allows achieving advantageous heating characteristics. In particular an especially even heating of a clamping region of a tool holder is advantageously achievable. An “at least partial rotational movement” is in particular to mean a rotation by at least a fraction of 360 degrees, e.g. 90 degrees, 180 degrees or 270 degrees. Alternatively or additionally it is conceivable that during the induction heating process, the tool holder and/or the induction coil go/goes through at least one full rotation or at least a plurality of full rotations. It is also conceivable that the induction coil and/or the tool holder are/is rotated oscillatingly. Further it is conceivable that the induction coil and/or the tool holder describes a helical line.

Beyond this it is proposed that a movement range of the induction coil, in which the induction coil is moved during the induction heating process, completely covers a region of the tool holder, in particular a clamping region of the tool holder, which is to be heated in the shrink-clamping process or in the unshrink-unclamping process. In this way advantageous heating characteristics are achievable. It is in particular advantageously possible to achieve an especially even heating of an entire clamping region of a tool holder. In particular the induction coil is translationally oscillated between two extreme points, whose distance and position along the axial direction of the tool holder corresponds to the region that is to be expanded to allow an insertion of a tool in the tool holder or a removal of the tool from the tool holder. In particular the distance between the extreme points at least substantially corresponds to a designated insertion depth and/or clamp-in depth of the tool in the tool holder. By a “region that is to be heated in the shrink-clamping process or in the unshrink-unclamping process” is in particular a region of the tool holder to be understood that must be heated to allow an insertion of a tool up to the designated insertion depth and/or clamp-in depth of the tool in the tool holder, or to allow a removal of a tool from the tool holder that is inserted in the tool holder with a defined insertion depth and/or clamp-in depth.

It is also proposed that a movement range of the induction coil is adjusted depending on the respective tool holder that is to be heated and/or depending on the respective tool that is to be shrink-clamped. As a result of this, advantageous heating characteristics are achievable. In particular especially even heating of an entire clamping region of a tool holder is advantageously achievable. Moreover a high degree of flexibility is achievable, in particular as it is possible to effectively shrink-clamp and/or unshrink-unclamp a plurality of different tools by the same induction heating device. In particular the movement range depends on an ideal and/or designated insertion depth and/or clamp-in depth of a respective tool in the tool holder. In particular a tool holder and a tool are identified before the induction heating process, in particular by the control and/or regulation unit of the induction heating device and/or of the shrink-clamping and/or unshrink-unclamping station, for example via camera recognition of tool information and/or tool holder information, or via an input and/or a read-out of tool information and/or tool holder information. In particular the movement range of the induction coil is determined and adjusted by the control and/or regulation unit on the basis of the tool information and/or tool holder information.

Furthermore it is proposed that the induction coil is moved in an axial direction within a maximum movement range of at least 5 mm, preferably at least 10 mm, advantageously at least 20 mm, especially advantageously at least 40 mm, preferentially at least 60 mm, and particularly preferably no more than 100 mm. This allows achieving advantageous heating characteristics. In particular it is in this way advantageously possible to travel along a plurality of different clamping regions, thus advantageously achieving a suitability of the method for a plurality of different tools and tool holders. By a “maximum movement range” is in particular a maximum range to be understood within which the extreme points of the translational oscillation of the induction coil can be located.

In addition it is proposed that the induction coil is, in particular translationally, moved in an oscillating manner with a frequency of at least 0.5 Hz, preferably at least 1 Hz, advantageously at least 2 Hz, especially advantageously at least 5 Hz, preferentially at least 10 Hz, and particularly preferably no more than 20 Hz. This allows achieving advantageous heating characteristics. In particular it is advantageously possible to achieve an especially even heating of an entire clamping region of a tool holder.

It is further proposed that, following a heating of the tool holder, the oscillating movement of the induction coil is used to apply cooling air onto the heated clamping region of the tool holder. This allows achieving advantageous shrink-clamping characteristics. It is advantageously possible to accelerate a cooling down and thus a shrink-clamping process. Advantageously it is possible to increase a work safety, in particular as hot tool holders are coolable in a quick, effective and automated manner. In particular the induction coil comprises at least one cooling unit having a nozzle that is configured to blow cooling air towards a tool holder clamped in the shrink-clamping and/or unshrink-unclamping station. In particular, by means of the oscillating movement of the induction coil and/or of the induction heating unit, the cooling air from the cooling unit is discharged in such a way that it is distributed over the entire clamping region of the tool holder.

Beyond this a shrink-clamping and/or unshrink-unclamping station for tools is proposed, with an induction heating device which comprises an induction coil for a shrink-clamping and/or unshrink-unclamping of tools into and/or from tool holders and which is configured at least for carrying out the method described above. In this way it is possible to achieve advantageous heating characteristics.

If the shrink-clamping and/or unshrink-unclamping station comprises a tower unit, which the induction heating device is coupled with and which comprises a drive unit that is at least configured for moving at least the induction heating unit of the induction heating device along the tower unit, the drive unit being configured at least for generating an oscillating movement of the induction heating device, in particular an oscillating movement of the induction heating unit relative to the tower unit, then advantageous heating characteristics are achievable. This in particular allows achieving a particularly simple method for generating the movement, in particular oscillating movement, of the induction coil.

It is also proposed that the induction heating device comprises at least one induction coil drive unit, which is configured to oscillatingly move the induction coil relative to the induction heating device, in particular relative to a housing of the induction heating unit. This allows achieving advantageous heating characteristics. Advantageously it is possible to keep an inertia of the moved parts of the induction heating device at an especially low level, as a result of which a particularly advantageous, in particular especially quick oscillation of the induction coil may be enabled. Moreover a wear-down is advantageously reducible.

In addition it is proposed that the shrink-clamping and/or unshrink-unclamping station comprises a cooling unit, which has at least one nozzle that is configured to blow cooling air towards a tool holder, the cooling unit being fixedly coupled with the induction heating device that is oscillatable along the axial direction. This allows achieving advantageous shrink-clamping characteristics. Advantageously it is possible to accelerate a cooling down and thus a shrink-clamping process. It is advantageously possible to increase work safety, in particular as hot tool holders are coolable in a quick, effective and automated manner. In particular the cooling unit comprises a plurality of nozzles, which are arranged in a distributed fashion. In particular the nozzles are arranged in a ring-shape around a common center of the cooling unit and the induction coil. In particular the cooling unit forms a cooling ring. In particular the cooling unit is implemented in such a way that it is movable together with the induction coil and/or with the induction heating device. As a result it is in particular possible that the cooling unit is movable, in the same way as the induction coil, along the axial direction of the induction coil and/or of the cooling unit in an oscillating manner.

The method according to the invention and the shrink-clamping and/or unshrink-unclamping station according to the invention are herein not to be limited to the application and implementation described above. In particular, to fulfill a functionality that is described here, the method according to the invention and the shrink-clamping and/or unshrink-unclamping station according to the invention may comprise a number of individual elements, structural components and units that differs from a number that is mentioned here.

### DRAWINGS

Further advantages will become apparent from the following description of the drawings. The drawings show an exemplary embodiment of the invention. The drawings, the description and the claims contain a plurality of features in combination. Someone skilled in the art will purposefully also consider the features individually and will find further expedient combinations.

It is shown in:

FIG. 1 a schematic sectional view of a shrink-clamping and/or unshrink-unclamping station with an induction heating device, and

FIG. 2 a flow chart of a method for heating a tool holder by means of the induction heating device.

### DESCRIPTION OF THE EXEMPLARY EMBODIMENT

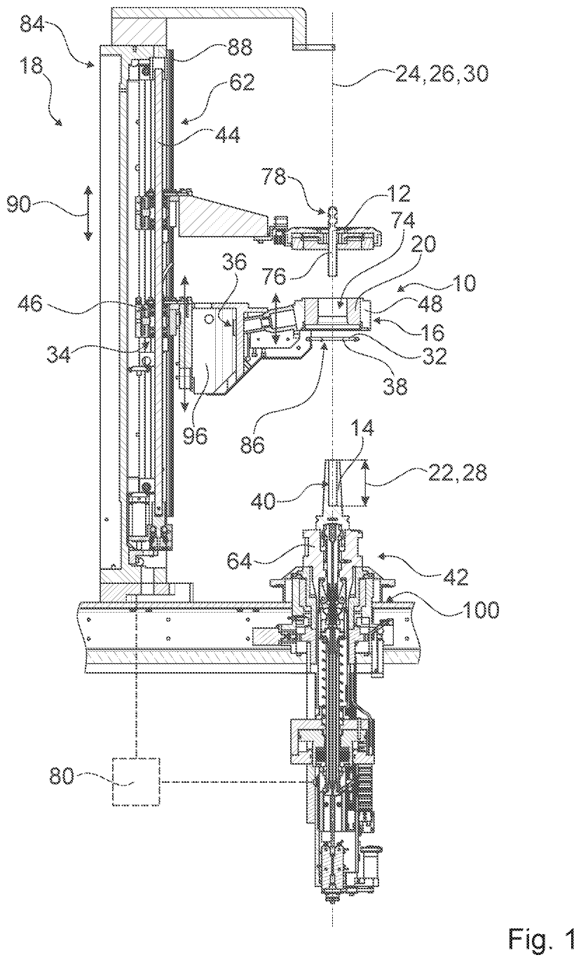

FIG. 1 shows a shrink-clamping and/or unshrink-unclamping station 18. The shrink-clamping and/or unshrink-unclamping station 18 is configured for an automated shrink-clamping and/or unshrink-unclamping of tools 12 into and/or from tool holders 14. The shrink-clamping and/or unshrink-unclamping station 18 is configured to carry out a shrink-clamping process on tools 12 for the purpose of a fixation of the tools 12 in tool holders 14 and/or to carry out an unshrink-unclamping process on tools 12 for the purpose of a removal of the tools 12 from tool holders 14. The shrink-clamping and/or unshrink-unclamping station 18 comprises an induction heating device 10. The induction heating device 10 is configured for a heating of the tool holders 14. The tool holders 14 are embodied as shrink-clamp chucks. The tool holders 14 comprise tool receiving openings 40. The tools 12 are implemented as shaft tools. The tools 12 respectively comprise a tool shaft 76. The tools 12 have a work region 78. The tool receiving openings 40 of the tool holders 14 are configured for receiving the tool shaft 76 of a tool 12. Preferentially the tool shaft 76 is, in a state when clamped in the tool holder 14, inserted in the tool receiving opening 40 of the tool holder 14 almost completely, in particular apart from a region measuring maximally 5 mm, preferably maximally 3 mm and preferentially maximally 2 mm. This region is equivalent to an ideal and/or designated insertion and/or clamping depth of the tools 12 in the tool holder 14.

The induction heating device 10 comprises an induction heating unit 16. The induction heating unit 16 is configured, in the shrink-clamping process and/or in the unshrink-unclamping process, to expand the tool receiving opening 40 of the tool holder 14 by heating. The induction heating unit 16 comprises precisely one induction coil 20. The induction coil 20 is implemented to be movable during an induction heating process. The induction coil 20 is implemented to be oscillatable during an induction heating process. The induction heating unit 16 is configured to generate an induction magnetic field. The induction magnetic field is configured to interact with the material of the tool holder 14 for the purpose of heating and thus for an expansion of the tool holder 14. The induction coil 20 comprises an opening 74. The opening 74 of the induction coil 20 is aligned in parallel to an axial direction 24 of the shrink-clamping and/or unshrink-unclamping station 18 and/or in parallel to an axial direction 24 of the induction coil 20. The induction coil 20 comprises coil windings which are wound around the opening 74 of the induction coil 20. The shrink-clamping and/or unshrink-unclamping station 18 comprises a control and/or regulation unit 80. The control and/or regulation unit 80 is configured at least for applying the induction coil 20 with an alternating current for a generation of an induction magnetic field. An extension of the induction coil 20 in the axial direction 24 corresponds to a minimum region which an induction magnetic field is applied to by the induction coil 20 during the shrink-clamping process or during the unshrink-unclamping process. The induction heating unit 16 comprises a cooling unit 86. The cooling unit 86 is arranged underneath the induction coil 20. The cooling unit 86 is configured for cooling the tool holder 14 subsequently to an insertion of a tool 12 in the tool holder 14 and/or subsequently to a removal of the tool 12 from the tool holder 14.

The cooling unit 86 comprises a nozzle 38. The nozzle 38 is configured to blow cooling air, in particular pressurized air, in a direction that is perpendicular to the axial direction 24 of the induction coil 20. The nozzle 38 is configured to blow cooling air towards a tool holder 14. The nozzle 38 is configured to blow cooling air onto a tool holder 14 previously heated by the induction coil 20. The cooling unit 86 is fixedly coupled with the induction heating device 10 that is capable of being oscillated along the axial direction 24. The cooling unit 86 is arranged underneath the induction coil 20. The cooling unit 86 forms a cooling ring 32. The cooling ring 32 comprises a plurality of nozzles 38, which are oriented toward an interior of the cooling ring 32. The induction coil 20 and the cooling ring 32 are centered around a shared axis 30, which extends along a center of the opening 74 of the induction coil 20.

The shrink-clamping and/or unshrink-unclamping station 18 comprises a tower unit 84. The induction heating device 10 is coupled with the tower unit 84. The tower unit 84, in particular a main extension direction 90 of the tower unit 84, extends in parallel to the axial direction 24 of the induction coil 20. The induction heating unit 16 is movably supported on the tower unit 84. The induction heating unit 16 comprises a carriage 96. The carriage 96 of the induction heating unit 16 is configured to movably support the induction unit 16 on the tower unit 84. Preferentially the induction heating unit 16 comprises at least two carriages 96, as a result of which a particularly high precision of the movement of the induction heating unit 16 is achievable. It is possible for the induction heating unit 16 to be moved up and down on the tower unit 84, along the main extension direction 90 of the tower unit 84. The induction heating unit 16 can be moved up and down on the tower unit 84 in a CNC-controlled manner. The control and/or regulation unit 80 is configured to control the movement of the induction heating unit 16 along the tower unit 84. The tower unit 84 comprises at least one guiding unit 62 with at least one guide rail 88 for guiding a movement of the induction heating unit 16. Preferably the guiding unit 62 comprises two guide rails 88 extending in parallel along the main extension direction 90 of the tower unit 84. This advantageously allows achieving a particularly linear movement guidance.

The shrink-clamping and/or unshrink-unclamping station 18 comprises a drive unit 34. The tower unit 84 comprises the drive unit 34. The drive unit 34 is configured to move the induction heating unit 16 of the induction heating device 10 along the axial direction 24 of the tower unit 84. The drive unit 34 is configured to generate an oscillating movement of the induction heating unit 16. The drive unit 34 is configured to move the induction heating unit 16, in particular the induction coil 20, during the induction heating process. The drive unit 34 is configured to move the induction heating unit 16, in particular the induction coil 20, in an oscillating manner during the induction heating process. The drive unit 34 is configured to generate an oscillating movement of the induction heating unit 16 relative to the tower unit 84. The drive unit 34 comprises a drive shaft 44. The drive shaft 44 is arranged at least to a large extent in the tower unit 84. The drive shaft 44 is configured for coupling with the induction heating device 10. In a state when coupled with the drive shaft 44, the induction heating unit 16 moves, in a rotation of the drive shaft 44, along the axial direction 24 upward or downward on the guide rail 88, depending on a rotation direction of the drive shaft 44. The induction heating device 10 is capable of being coupled with the drive shaft 44 via a rolling ring drive 46. Together with the drive shaft 44 the rolling ring drive 46 realizes an Uhing drive. Alternative drive units, in particular drive units differing from an Uhing drive, are conceivable.

The induction heating device 10 comprises an induction coil drive unit 36. The induction coil drive unit 36 is implemented separately from the drive unit 34 of the tower unit 84. The induction coil drive unit 36 is implemented separately from the tower unit 84. The induction coil drive unit 36 is configured to oscillatingly move the induction coil 20 relative to the induction heating device 10. The induction heating device 10 comprises a housing 48. The induction coil drive unit 36 is configured to oscillatingly move the induction coil 20 relative to the housing 48 of the induction heating unit 16. Alternatively or additionally the induction coil drive unit 36 or a further induction coil drive unit (not shown) are/is configured for rotating the induction coil 20 around a rotation axis 26 during the induction heating process. The rotation axis 26 of the induction coil 20 extends in parallel to the axial direction 24 of the tool holder 14. The induction coil 20 is configured to be moved within a limited movement range 28 during the induction heating process. The induction coil 20 is configured to oscillate within the movement range 28 during the induction heating process. The movement range 28 extends over an entire region of the tool holder 14 that is to be heated in the shrink-clamping process or in the unshrink-unclamping process. The movement range 28 extends over a clamping region 22 of the tool holder 14. The extension of the movement range 28, in particular along the axial direction 24, depends on the tool holder 14 that is to be heated, in particular from the measurements of the tool holder 14 that is to be heated and of the tool 12 that is to be fixated. The control and/or regulation unit 80 is configured to adjust the movement range 28 depending on a tool holder type and/or on a tool type.

The shrink-clamping and/or unshrink-unclamping station 18 comprises a holding device 42. The holding device 42 is configured for holding a tool holder 14 in the shrink-clamping and/or unshrink-unclamping station 18. The holding device 42 comprises a spindle unit 100. The spindle unit 100 is rotatable. The spindle unit 100 is fixedly connected with a basis unit (not shown) of the shrink-clamping and/or unshrink-unclamping station 18. The holding unit 42 comprises an attachment holder 64. The attachment holder 64 is insertable in the spindle unit 100 in an exchangeable fashion. The attachment holder 64 is configured to provide a suitable receiving region for a certain tool holder type.

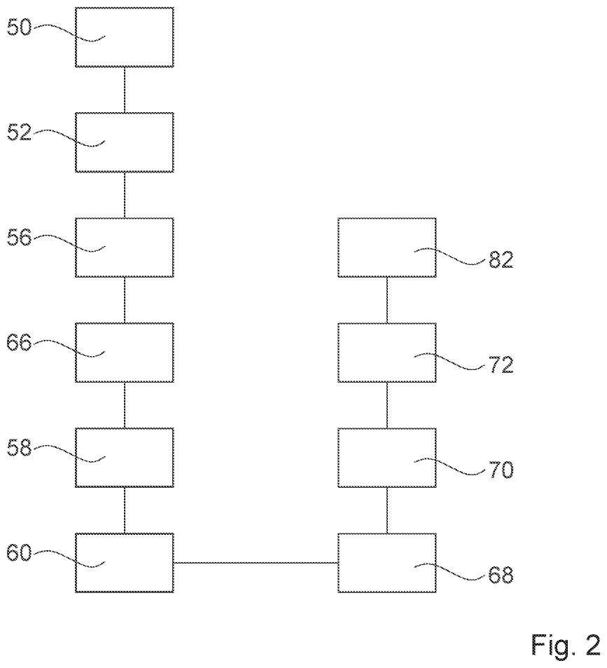

FIG. 2 shows a flow chart of a method for a heating of a tool holder 14 by means of an induction heating device 10. In at least one method step 50 a tool holder 14 is inserted into the holding device 42 of the shrink-clamping and/or unshrink-unclamping station 18. If the tool holder 14 has a tool 12 fixated therein, an unshrink-unclamping process is then carried out. If the tool holder 14 does not have a tool fixated therein, a shrink-clamping process is then carried out. The method steps explained below may be implemented in similar ways in each of the two cases. In at least one method step 52 the tool holder type of the tool holder 14 inserted in the shrink-clamping and/or unshrink-unclamping station 18 is input by an operator or is automatically detected by a read-out of a coding, e.g. a QR code, a barcode or an RFID chip, or via an image recognition by a camera system. In at least one further method step 56 a length of the tool holder 14, a diameter of the tool receiving opening 40 and/or an ideal shrinking and/or clamping depth are/is determined on the basis of the identified tool holder type. In the method step 56 the region of the tool holder 14 that is to be heated is determined on the basis of the identified tool holder type. In the method step 56 the clamping region 22 is determined on the basis of the identified tool holder type.

In at least one further method step 66 the movement range 28 of the induction coil 20 is adjusted depending on the respective tool holder 14 that is to be heated, in particular depending on the clamping region 22 of the tool holder 14. In the method step 66 it is determined via the control and/or regulation unit 80 whether and to what extent the induction coil 20 needs to be moved to achieve an even heating of the entire clamping region 22. In the method step 66 the drive unit 34 and/or the induction coil drive unit 36 are/is programmed. In the method step 66 a trajectory is adjusted that is to be traveled by the induction coil 20 during the induction heating process. In at least one further method step 58 the induction coil 20 is activated for a generation of an induction magnetic field. In the method step 58 the induction heating process is started for the purpose of expanding the tool receiving opening 40 of the tool holder 14. In at least one further method step 60 the induction coil 20 is moved in an oscillating manner during the induction heating process. In the method step 60 the induction coil 20 is moved during the induction heating process along the axial direction 24 of the tool holder 14 that is to be heated. In the method step 60 the induction coil 20 is moved in such a way that the movement range 28 of the induction coil 20 completely covers a region of the tool holder 14 that is to be heated in the induction heating process. In the method step 60 the induction coil 20 is moved in such a way that the movement range 28 of the induction coil 20 completely covers the clamping region 22 of the tool holder 14. The movement range 28, within which the induction coil 20 is maximally moved in the axial direction 24 during the induction heating process, measures 20 mm in the exemplary embodiment shown. Differing maximum movement ranges 28 are conceivable. A frequency which the induction coil 20 is moved with during the induction heating process is 2 Hz in the exemplary embodiment shown. Differing frequencies are conceivable. If the clamping region 22 has an extension that is at least substantially equivalent to the extension of the induction coil 20 in the axial direction 24, it is conceivable that the induction coil 20 remains in such a case immobile during the induction heating process.

In at least one further method step 68 the induction coil 20 is rotationally moved during the induction heating process around the rotation axis 26 that extends in parallel to the axial direction 24 of the tool holder 14. In at least one further method step 70 the tool holder 14 is rotationally moved during the induction heating process around the rotation axis 26 that extends in parallel to the axial direction 24 of the tool holder 14. In at least one further method step 72, subsequently to a heating of the clamping region 22 of the tool holder 14, the clamping region 22 of the tool holder 14 is actively cooled. In the method step 72 the oscillating movement of the induction coil 20 is used for applying cooling air onto the entire previously heated clamping region 22 of the tool holder 14. In at least one further method step 82 the cooled tool holder 14 and/or the tool 12 are/is removed from the shrink-clamping and/or unshrink-unclamping station 18.

1. A method for a heating of a tool holder by means of an induction heating device for the purpose of a shrink-clamping and/or unshrink-unclamping of tools into and/or from tool holders, wherein an induction heating unit comprises at least one, preferably exclusively one, induction coil and is configured to expand by heating at least a portion of the tool holder, in particular at least a clamping region of the tool holder, in a shrink-clamping process or in an unshrink-unclamping process, wherein at least the induction coil is moved during an induction heating process.

2. The method according to claim 1, wherein the induction coil is moved oscillatingly during the induction heating process.

3. The method according to claim 1, wherein during the induction heating process, the induction coil is moved along an axial direction of the tool holder that is to be heated.

4. The method according to claim 1, wherein during the induction heating process, the induction coil and/or the tool holder are/is rotationally moved at least partially around a rotation axis that extends in parallel to an axial direction of the tool holder.

5. The method according to claim 1, wherein a movement range of the induction coil, in which the induction coil is moved during the induction heating process, completely covers a region of the tool holder, in particular the clamping region of the tool holder, which is to be heated in the shrink-clamping process or in the unshrink-unclamping process.

6. The method according to claim 1, wherein a movement range of the induction coil is adjusted depending on the respective tool holder that is to be heated.

7. The method according to claim 1, wherein the induction coil is moved in an axial direction within a maximum movement range of at least 5 mm, preferably at least 10 mm, advantageously at least 20 mm, especially advantageously at least 40 mm, preferentially at least 60 mm, and particularly preferably no more than 100 mm.

8. The method according to claim 2, wherein the induction coil is moved in an oscillating manner with a frequency of at least 0.5 Hz, preferably at least 1 Hz, advantageously at least 2 Hz, especially advantageously at least 5 Hz, preferentially at least 10 Hz, and particularly preferably no more than 20 Hz.

9. The method according to claim 2, wherein following a heating of the tool holder, the oscillating movement of the induction coil is used to apply cooling air onto the heated clamping region of the tool holder.

10. A shrink-clamping and/or unshrink-unclamping station for tools, with an induction heating device for a shrink-clamping and/or unshrink-unclamping of tools into and/or from tool holders, which comprises an induction coil and which is configured at least for carrying out a method according to claim 1.

11. The shrink-clamping and/or unshrink-unclamping station according to claim 10, further comprising a tower unit, which the induction heating device is coupled with and which comprises a drive unit that is at least configured for moving at least the induction heating unit of the induction heating device along the tower unit, the drive unit being configured at least for generating an oscillating movement of the induction heating device, in particular an oscillating movement of the induction heating device relative to the tower unit.

12. The shrink-clamping and/or unshrink-unclamping station according to claim 10, wherein the induction heating device comprises at least one induction coil drive unit, which is configured to oscillatingly move the induction coil relative to the induction heating device in particular relative to a housing of the induction heating device.

13. The shrink-clamping and/or unshrink-unclamping station according to claim 10, further comprising a cooling unit, which has at least one nozzle that is configured to blow cooling air towards a tool holder, the cooling unit being fixedly coupled with the induction heating device that is oscillatable along the axial direction.
